(19) United States
(12) Patent Application Publication
(10) Pub. No.: US 2007/0159622 A1
(43) Pub. Date: Jul. 12, 2007

(54) Method of measuring the magnification of a projection system, device manufacturing method and computer program product

(75) Inventors: Bearrach Moest, Eindhoven (NL); Arnout Van De Stadt, Eindhoven (NL); Cornelis Andreas Francisus Johannes Van Der Poel, Helmond (NL)

Correspondence Address: PILLSBURY WINTHROP SHAW PITTMAN, LLP, P.O. BOX 10500, MCLEAN, VA, 22102, US

(73) Assignee: ASML Netherlands B.V., Veldhoven (NL)

(21) Appl. No.: 11/603,256

(22) Filed: Nov. 22, 2006

Related U.S. Application Data
(63) Continuation-in-part of application No. 11/285,766, filed on Nov. 23, 2005.

(51) Int. Cl. G01B 9/00

(52) U.S. Cl. 356/124

(57) ABSTRACT

A transmission image sensor is provided that is optimized for detection of an alignment marker that includes gratings, which are used to detect the position of a part of an overlay marker, e.g. of box-in-box type. Both the alignment markers and the overlay markers may be used to derive a measurement of magnification of a projection system. Magnification values obtained from the overlay marker components using the transmission image sensors link the values conventionally obtained using the transmission image sensor to detect alignment markers and an off-line tool to detect overlay markers.

### CROSS-REFERENCE TO RELATED APPLICATION

This application is a continuation-in-part of pending U.S. patent application Ser. No. 11/285,766 which was filed on Nov. 23, 2005, the entire contents of which are incorporated herein by reference.

### FIELD OF THE INVENTION

The present invention relates to a method of measuring the magnification of a projection system for lithographic apparatus, to device manufacturing methods using lithographic apparatus, and to computer program products.

### BACKGROUND OF THE INVENTION

A lithographic apparatus is a machine that applies a desired pattern onto a substrate, usually onto a target portion of the substrate. A lithographic apparatus can be used, for example, in the manufacture of integrated circuits (ICs). In that instance, a patterning device, which is alternatively referred to as a mask or a reticle, may be used to generate a circuit pattern to be formed on an individual layer of the IC. This pattern can be transferred onto a target portion (e.g. comprising part of, one, or several dies) on a substrate (e.g. a silicon wafer). Transfer of the pattern is typically via imaging onto a layer of radiation-sensitive material (resist) provided on the substrate. In general, a single substrate will contain a network of adjacent target portions that are successively patterned. Known lithographic apparatus include so-called steppers, in which each target portion is irradiated by exposing an entire pattern onto the target portion at one time, and so-called scanners, in which each target portion is irradiated by scanning the pattern through a radiation beam in a given direction (the “scanning”-direction) while synchronously scanning the substrate parallel or anti-parallel to this direction. It is also possible to transfer the pattern from the patterning device to the substrate by imprinting the pattern onto the substrate.

In device manufacturing methods using lithographic apparatus, an important factor in the yield, i.e. the percentage of correctly manufactured devices, is the accuracy within which layers are printed in relation to layers that have previously been formed. This is known as overlay and the overlay error budget will often be 10 nm or less. To achieve such accuracy, the substrate must be aligned to the mask pattern to be printed with great accuracy.

One known process for aligning the substrate and mask is known as off-line alignment and is performed in lithographic apparatus having separate measurement and exposure stations. It is a two-step process. First, at the measurement station, the positions of a plurality of, e.g. sixteen, alignment markers printed on the substrate relative to one or more fixed markers, known as fiducials, provided on the substrate table are measured and stored. Then, the substrate table, with substrate still firmly fixed thereto, is transferred to the exposure station. The fiducial, as well as a marker detectable by an alignment sensor, also comprises a transmission image sensor (TIS). This is used to locate in space the position of an aerial image of a mask marker contained in the mask pattern that is to be exposed onto the substrate. Knowing the position of the TIS, and hence the fixed markers, relative to the image of the mask marker and also the positions of the substrate alignment markers relative to the fixed markers, it is possible to position the substrate in a desired position for correct exposure of the substrate to the mask pattern.

Another important factor in determining the overlay of printed layers is the magnification of the projection system, in particular any deviations from its nominal value of ¼ or ⅕. Since the magnification of the projection system can normally be adjusted by adjusting the position of an element in the system, it is normal to measure the magnification periodically and adjust as necessary. This can be done by printing two or more spaced-apart alignment markers in a single exposure and measuring their relative positions using the integrated alignment system. Any deviation from the expected separation indicates a magnification error.

As a quality control measure it is common, when printing device layers, to also print one or more overlay markers. Overlay markers have two or more components, which are printed in separate device layers or on the same layer, but using overlapping fields. The overlay marker is designed such that any errors in the relative positioning of the layers or overlapping fields in which the two components were printed, i.e. overlay errors, are apparent when the whole marker is examined in an off-line tool, such as a high-magnification microscope or a scatterometer. If multiple overlay markers are printed in a single device then, as with the alignment markers, the magnification of the projection system can be determined by measuring the separations of the overlay markers. Some overlay markers may also be, or have components that are, susceptible to magnification error.

Thus, it is possible to obtain two independent measurements of the magnification of the projection system of a lithographic apparatus—one from alignment markers and one from overlay markers. If these two measurements differ, it is difficult to know what is the “true” magnification of the projection system. This can be particularly important when it is necessary to overlay layers that are printed with different apparatus, particularly apparatus of different types as opposed to different examples of the same type. The two independent measurements of the magnification may differ because in many cases, especially when off-axis illumination is used to print the device layers, magnification is dependent on factors such as feature size, density and the illumination setting used.

### SUMMARY OF THE INVENTION

It is therefore desirable to provide an improved method for determining the magnification of a projection system for use in projection lithography.

According to an aspect of the invention, there is provided a method of measuring the magnification of a projection system of a lithographic projection apparatus which has an image sensor capable of sensing an aerial image projected by the projection system, the method comprising:

projecting an image of a component of a two-component marker, the two-component marker being sensitive to overlay errors between printing of its two components; and

measuring the position of the component of the two-component marker in the projected image using the image sensor.

According to an aspect of the invention, there is provided a device manufacturing method using a lithographic projection apparatus which has a projection system and an image sensor capable of sensing an aerial image projected by the projection system, the method comprising:

projecting an image of a component of a two-component marker, the two-component marker being sensitive to overlay errors between printing of its two components;

measuring the position of the component of the two-component marker in the projected image using the image sensor;

determining from the measured position a value indicative of the magnification of the projection system; and

projecting the image onto a substrate.

According to an aspect of the invention, there is provided a computer program product comprising program code to control a lithographic apparatus, which has a projection system and an image sensor capable of sensing an aerial image projected by the projection system, to perform a method of measuring the magnification of the projection system, the method comprising:

projecting an image of a component of a two-component marker, the two-component marker being sensitive to overlay errors between printing of its two components; and

measuring the position of the component of the two-component marker in the projected image using the image sensor.

### BRIEF DESCRIPTION OF THE DRAWINGS

Embodiments of the invention will now be described, by way of example only, with reference to the accompanying schematic drawings in which corresponding reference symbols indicate corresponding parts, and in which:

FIG. 1 depicts a lithographic apparatus according to an embodiment of the invention;

FIG. 2 depicts the substrate stage of the apparatus of FIG. 1;

FIG. 3 depicts a substrate alignment marker;

FIG. 4 depicts a transmission image sensor;

FIG. 5 depicts an overlay marker;

FIG. 6 depicts a method according to an embodiment of the invention; and

FIG. 7 depicts an example of fitting lines to detector output data to determine the center of a marker.

### DETAILED DESCRIPTION

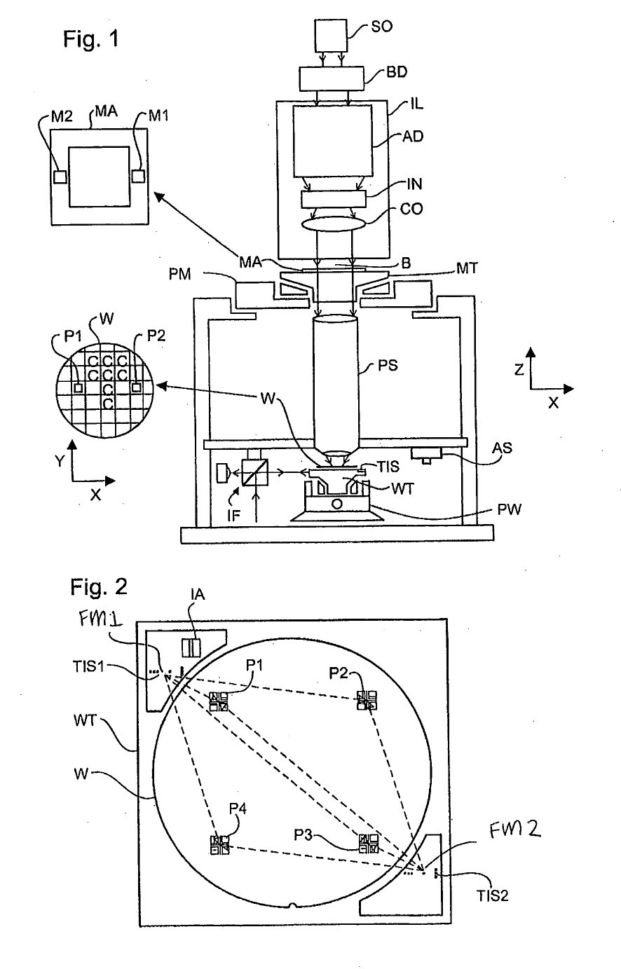

FIG. 1 schematically depicts a lithographic apparatus according to one embodiment of the invention. The apparatus comprises:

an illumination system (illuminator) IL configured to condition a radiation beam B (e.g. UV radiation or DUV radiation);

a support structure (e.g. a mask table) MT constructed to support a patterning device (e.g. a mask) MA and connected to a first positioner PM configured to accurately position the patterning device in accordance with certain parameters;

a substrate table (e.g. a wafer table) WT constructed to hold a substrate (e.g. a resist-coated wafer) W and connected to a second positioner PW configured to accurately position the substrate in accordance with certain parameters; and

a projection system (e.g. a refractive projection lens system) PS configured to project a pattern imparted to the radiation beam B by patterning device MA onto a target portion C (e.g. comprising one or more dies) of the substrate W.

The illumination system may include various types of optical components, such as refractive, reflective, magnetic, electromagnetic, electrostatic or other types of optical components, or any combination thereof, for directing, shaping, or controlling radiation.

The support structure supports, i.e. bears the weight of, the patterning device. It holds the patterning device in a manner that depends on the orientation of the patterning device, the design of the lithographic apparatus, and other conditions, such as for example whether or not the patterning device is held in a vacuum environment. The support structure can use mechanical, vacuum, electrostatic or other clamping techniques to hold the patterning device. The support structure may be a frame or a table, for example, which may be fixed or movable as required. The support structure may ensure that the patterning device is at a desired position, for example with respect to the projection system. Any use of the terms “reticle” or “mask” herein may be considered synonymous with the more general term “patterning device.”

The term “patterning device” used herein should be broadly interpreted as referring to any device that can be used to impart a radiation beam with a pattern in its cross-section such as to create a pattern in a target portion of the substrate. It should be noted that the pattern imparted to the radiation beam may not exactly correspond to the desired pattern in the target portion of the substrate, for example if the pattern includes phase-shifting features or so called assist features. Generally, the pattern imparted to the radiation beam will correspond to a particular functional layer in a device being created in the target portion, such as an integrated circuit.

The patterning device may be transmissive or reflective. Examples of patterning devices include masks, programmable mirror arrays, and programmable LCD panels. Masks are well known in lithography, and include mask types such as binary, alternating phase-shift, and attenuated phase-shift, as well as various hybrid mask types. An example of a programmable mirror array employs a matrix arrangement of small mirrors, each of which can be individually tilted so as to reflect an incoming radiation beam in different directions. The tilted mirrors impart a pattern in a radiation beam which is reflected by the mirror matrix.

The term “projection system” used herein should be broadly interpreted as encompassing any type of projection system, including refractive, reflective, catadioptric, magnetic, electromagnetic and electrostatic optical systems, or any combination thereof, as appropriate for the exposure radiation being used, or for other factors such as the use of an immersion liquid or the use of a vacuum. Any use of the term “projection lens” herein may be considered as synonymous with the more general term “projection system”.

As here depicted, the apparatus is of a transmissive type (e.g. employing a transmissive mask). Alternatively, the apparatus may be of a reflective type (e.g. employing a programmable mirror array of a type as referred to above, or employing a reflective mask).

The lithographic apparatus may be of a type having two (dual stage) or more substrate tables (and/or two or more mask tables). In such “multiple stage” machines the additional tables may be used in parallel, or preparatory steps may be carried out on one or more tables while one or more other tables are being used for exposure.

The lithographic apparatus may also be of a type wherein at least a portion of the substrate may be covered by a liquid having a relatively high refractive index, e.g. water, so as to fill a space between the projection system and the substrate. An immersion liquid may also be applied to other spaces in the lithographic apparatus, for example, between the mask and the projection system. Immersion techniques are well known in the art for increasing the numerical aperture of projection systems. The term “immersion” as used herein does not mean that a structure, such as a substrate, must be submerged in liquid, but rather only means that liquid is located between the projection system and the substrate during exposure.

Referring to FIG. 1, the illuminator IL receives a radiation beam from a radiation source SO. The source and the lithographic apparatus may be separate entities, for example when the source is an excimer laser. In such cases, the source is not considered to form part of the lithographic apparatus and the radiation beam is passed from the source SO to the illuminator IL with the aid of a beam delivery system BD comprising, for example, suitable directing mirrors and/or a beam expander. In other cases the source may be an integral part of the lithographic apparatus, for example when the source is a mercury lamp. The source SO and the illuminator IL, together with the beam delivery system BD if required, may be referred to as a radiation system.

The illuminator IL may comprise an adjuster AD for adjusting the angular intensity distribution of the radiation beam. Generally, at least the outer and/or inner radial extent (commonly referred to as σ-outer and σ-inner, respectively) of the intensity distribution in a pupil plane of the illuminator can be adjusted. In addition, the illuminator IL may comprise various other components, such as an integrator IN and a condenser CO. The illuminator may be used to condition the radiation beam, to have a desired uniformity and intensity distribution in its cross-section.

The radiation beam B is incident on the patterning device (e.g., mask MA), which is held on the support structure (e.g., mask table MT), and is patterned by the patterning device. Having traversed the mask MA, the radiation beam B passes through the projection system PS, which focuses the beam onto a target portion C of the substrate W. With the aid of the second positioner PW and position sensor IF (e.g. an interferometric device, linear encoder or capacitive sensor), the substrate table WT can be moved accurately, e.g. so as to position different target portions C in the path of the radiation beam B. Although only two substrate alignment markers are illustrated, more can be used to improve the determination of the location of the substrate. Similarly, the first positioner PM and another position sensor (which is not explicitly depicted in FIG. 1) can be used to accurately position the mask MA with respect to the path of the radiation beam B, e.g. after mechanical retrieval from a mask library, or during a scan. In general, movement of the mask table MT may be realized with the aid of a long-stroke module (coarse positioning) and a short-stroke module (fine positioning), which form part of the first positioner PM. Similarly, movement of the substrate table WT may be realized using a long-stroke module and a short-stroke module, which form part of the second positioner PW. In the case of a stepper (as opposed to a scanner) the mask table MT may be connected to a short-stroke actuator only, or may be fixed. Mask MA and substrate W may be aligned using mask alignment markers M1, M2 and substrate alignment markers P1, P2. Although the substrate alignment markers as illustrated occupy dedicated target portions, they may be located in spaces between target portions (these are known as scribe-lane alignment markers). Similarly, in situations in which more than one die is provided on the mask MA, the mask alignment markers may be located between the dies.

The depicted apparatus could be used in at least one of the following modes:

1. In step mode, the mask table MT and the substrate table WT are kept essentially stationary, while an entire pattern imparted to the radiation beam is projected onto a target portion C at one time (i.e. a single static exposure). The substrate table WT is then shifted in the X and/or Y direction so that a different target portion C can be exposed. In step mode, the maximum size of the exposure field limits the size of the target portion C imaged in a single static exposure.

2. In scan mode, the mask table MT and the substrate table WT are scanned synchronously while a pattern imparted to the radiation beam is projected onto a target portion C (i.e. a single dynamic exposure). The velocity and direction of the substrate table WT relative to the mask table MT may be determined by the (de-)magnification and image reversal characteristics of the projection system PS. In scan mode, the maximum size of the exposure field limits the width (in the non-scanning direction) of the target portion in a single dynamic exposure, whereas the length of the scanning motion determines the height (in the scanning direction) of the target portion.

3. In another mode, the mask table MT is kept essentially stationary holding a programmable patterning device, and the substrate table WT is moved or scanned while a pattern imparted to the radiation beam is projected onto a target portion C. In this mode, generally a pulsed radiation source is employed and the programmable patterning device is updated as required after each movement of the substrate table WT or in between successive radiation pulses during a scan. This mode of operation can be readily applied to maskless lithography that utilizes programmable patterning device, such as a programmable mirror array of a type as referred to above.

Combinations and/or variations on the above described modes of use or entirely different modes of use may also be employed.

The apparatus also comprises an alignment sensor AS, which may be mounted at the measurement station of a dual stage apparatus, which is used to detect alignment markers printed on a substrate W and also fixed markers (fiducials) provided on the substrate table. This can be seen in FIG. 2, which shows four alignment markers P1-P4 printed on the substrate and two fixed markers FM1,FM2 located on the substrate plates TIS1, TIS2, respectively, provided on the substrate table WT. The substrate table may also have on it a sensor IA for an interferometric system that measures properties of the projection system, e.g. aberrations, and sensors for other systems that involve detection of a property of an image projected by projection system PS. By scanning the substrate table WT under the alignment sensor AS whilst keeping track of its movements using the displacement measurement system IF, the positions, shown by dashed arrows, of the substrate markers P1-P4 relative to the two fixed markers FM1,FM2 located on the substrate plates TIS1, TIS2 can be determined.

The two substrate plates TIS1, TIS2 have integrated into them two image sensors that can be used to determine the location of an image of a mask marker by scanning the image sensor through the aerial image. Thus the relative position of the image of the mask marker and the fixed markers can be determined and the previously obtained relative positions of the substrate markers allow the substrate to be positioned at any desired position relative to the projected image with great accuracy.

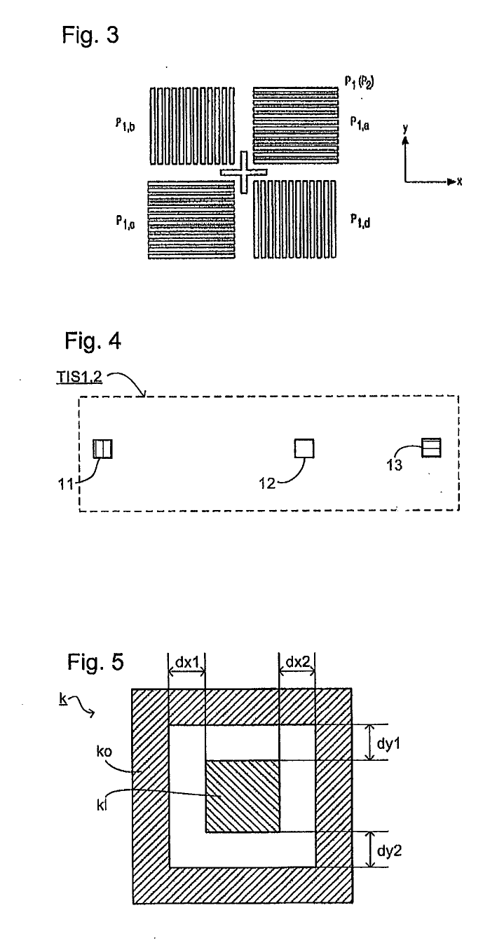

FIG. 3 shows an alignment marker P₁ which may be used in an embodiment of the invention. As can be seen it comprises four gratings—a pair aligned parallel to the x direction and a pair parallel to the y direction—arranged in a square. Of each pair, one has a predetermined pitch, e.g. 16 μm, and the other has a pitch 11/10 times the predetermined pitch, e.g. 17.6 μm. By scanning the marker relative to a sensor which separately senses radiation diffracted from each grating, the center of the marker can be detected by detecting when peaks in the outputs related to each grating coincide. Further details of an off-axis alignment system that can be used to detect such markers are given in EP 0 906 590 A, which document is hereby incorporated by reference in its entirety.

The image sensors mentioned above operate in a similar manner and are shown in FIG. 4. Each image sensor comprises three photo-sensitive detectors 11 to 13. The photo-sensitive detector 11 is covered by an opaque, e.g. chrome, layer into which are edged gratings with lines extending in the Y direction whilst detector 13 is similar but the lines of the gratings extend in the X direction. The other photo-sensitive detector 12 is not covered by a layer. As the photo-sensitive detectors are scanned through an aerial image of gratings corresponding to those provided over the detectors, the outputs of the detectors will fluctuate as bright parts of the image of the marker gratings and the apertures of the gratings etched in the opaque layer move into and out of registration. The center of each grating in x, y, is detected when the fit on the output signal peaks. By scanning the sensor through the marker at different positions along the Z axis, the plane of best focus can be detected by detecting the level at which the fluctuations in the outputs of the detectors have the greatest amplitude. The central, uncovered detector 12 can be used to find a coarse position for the gratings in the aerial image in a known capture procedure and can also be used to normalize the signals from the grating detectors to remove fluctuations due to changes in the output of the illumination system IL, e.g. due to source power variations.

A conventional overlay marker k is shown in FIG. 5. This is of a type known as box-in-box and comprises two components—an outer open box ko and an inner closed box or square ki—which are printed in separate layers of a device or different, but overlapping fields. After development and/or processing of the layer where the last box (inner, outer or both) is printed, the (average) values of the separation between the inner circumference of the outer box and the outer perimeter of the inner square on the left dx1, right dx2, top dy1 and bottom dy2 sides are measured, for example using a high magnification microscope such as a scanning electron microscope. The overlay error between the layers or fields in which the inner and the outer boxes were printed is then given as (dx1−dx2)/2 in the x direction and (dy1−dy2)/2 in the y direction. Other forms of overlay marker are known and can be used in the methods of the present invention.

Both the alignment markers and the overlay markers can be used to derive a measurement of magnification of the projection system. In general, multiple examples of each type of marker will be printed from a single mask image, for example spaced around the outside of each device in the scribe layers. Since the relative positions of the markers in the mask is known, by measuring the separations of the markers as printed on the substrate using an offline tool, or in the aerial image in the case of the alignment markers using an integrated sensor, the magnification of the projection system can be derived by simple calculation. It should be noted that the magnification may in practice not be the same in all directions and may not be uniform across the field. Hence, the term “magnification” as used herein may refer to a plurality of values, a map or a matrix, as most convenient to express the available information.

Inevitably when measuring the same parameter of a real object with two different devices, the magnification as measured by the off-line tool and by the integrated sensor may differ. This can happen in particular because the magnification of the projection system may be dependent on factors such as illumination mode as well as feature shape, orientation and density. There is then a question as to which value for magnification is to be regarded as correct. In many cases the values generated by the off-line tool will be taken as correct since this allows comparisons between different lithographic apparatus.

A reliable detection of the aerial image of a component of an overlay marker, such as that shown in FIG. 5, can be made using a transmission image sensor. This is in spite of the fact that the transmission image sensor is optimized to detect images of specific markers, such as shown in FIG. 4. Therefore, the positions of components of the overlay marker in the aerial image can be obtained using the transmission image sensors located on plates TIS1, TIS2, and in the same way as described above value(s) for magnification can be obtained.

The aerial image of the component of the overlay marker can be detected by scanning one of the photo-sensitive detectors 11-13 through it and processing the resulting signal using a suitable algorithm, dependent on the exact form of the marker being detected and detector being used. For example, using the uncovered detector 12, which provides the largest output signal and which in a particular embodiment of the invention is substantially square having sides in the range of from 10 to 40 μm, to detect the image of the central box of a box-in-box marker, the detector 12 is scanned through the image and provides a trapezoidal output signal as shown in FIG. 7. Initially the output is low, where no image is detected. As the leading edge of the detector moves into the image of the box, the detector signal rises steadily until the whole of the detector is within the image. There is then a plateau portion until the detector begins to leave the image of the box and the output signal declines to a low level. The width of the trapezoidal output signal depends on the width of the inner box as well as on the width of the detector. By fitting straight lines to the two sloping portions of the output signal and calculating their intersection, the position of the center of the image can be obtained.

As mentioned above, the exact form of the overlay marker can be different from a box-in-box marker but it is desirable for ease of fitting that the image at substrate level is symmetrical about a line perpendicular to the direction that the sensor is scanned through it (the scan direction) and/or smaller than the sensor. The image can be a simple feature of a complex marker rather than the whole marker.

The magnification values obtained from the overlay marker components using the transmission image sensors link the values conventionally obtained using the transmission image sensor to detect mask alignment markers and an off-line tool to detect overlay markers. The magnification determination according to embodiments of the invention hence can be used to provide an early prediction of the magnification that will be obtained using the off-line tool after development and/or processing of the substrate. This enables corrective action, for example adjusting the magnification of the projection system using adjustable elements within it, to be taken if necessary before exposure, improving yield and throughput. The additional magnification values are also useful in calibration of the lithographic apparatus and in identifying the source of magnification and/or overlay problems.

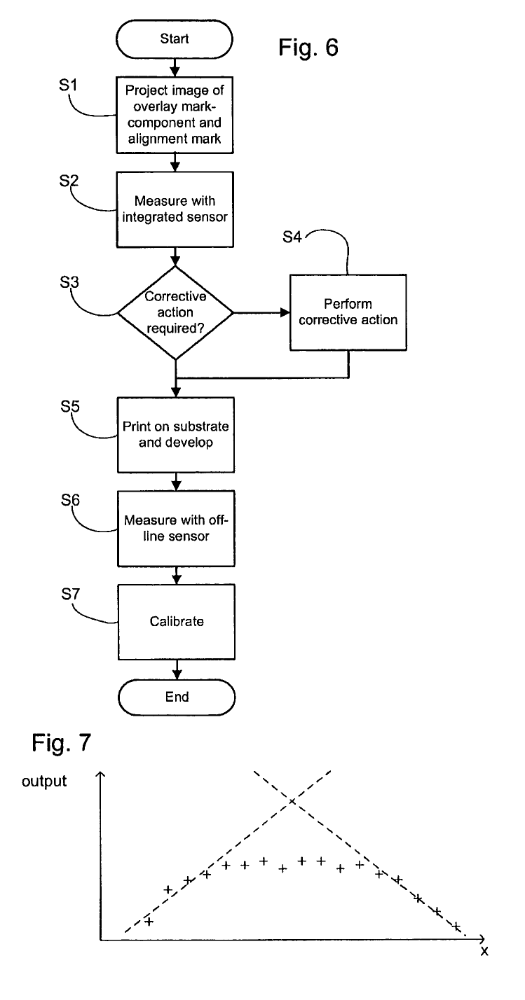

Thus a method according to an embodiment of the invention, as shown in FIG. 6, comprises:

at operation S1, projecting an image of a component of at least one overlay marker and at least one mask alignment marker;

at operation S2, measuring the positions of the component of at least one overlay marker and optionally at least one mask alignment marker;

at operation S3, determining whether any corrective action is required and if so performing it at operation S4;

at operation S5, printing a device pattern and the component of at least one overlay marker and optionally at least one alignment marker;

at operation S6, measuring the overlay marker using an off-line tool to derive, inter alia, a value for magnification; and

at operation S7, calibrating or re-calibrating the lithographic apparatus if necessary.

Furthermore, the method described can also be used not only for determination of the magnification of the projection system, but also for determination of translation in x and y (Tx and Ty) and rotation around the z axis (Rz) of the reticle.

Although specific reference may be made in this text to the use of lithographic apparatus in the manufacture of ICs, it should be understood that the lithographic apparatus described herein may have other applications, such as the manufacture of integrated optical systems, guidance and detection patterns for magnetic domain memories, flat-panel displays, liquid-crystal displays (LCDs), thin-film magnetic heads, etc. The skilled artisan will appreciate that, in the context of such alternative applications, any use of the terms “wafer” or “die” herein may be considered as synonymous with the more general terms “substrate” or “target portion”, respectively. The substrate referred to herein may be processed, before or after exposure, in for example a track (a tool that typically applies a layer of resist to a substrate and develops the exposed resist), a metrology tool and/or an inspection tool. Where applicable, the disclosure herein may be applied to such and other substrate processing tools. Further, the substrate may be processed more than once, for example in order to create a multi-layer IC, so that the term substrate used herein may also refer to a substrate that already contains multiple processed layers.

Although specific reference may have been made above to the use of embodiments of the invention in the context of optical lithography, it will be appreciated that the invention may be used in other applications, for example imprint lithography, and where the context allows, is not limited to optical lithography. In imprint lithography a topography in a patterning device defines the pattern created on a substrate. The topography of the patterning device may be pressed into a layer of resist supplied to the substrate whereupon the resist is cured by applying electromagnetic radiation, heat, pressure or a combination thereof. The patterning device is moved out of the resist leaving a pattern in it after the resist is cured.

The terms “radiation” and “beam” used herein encompass all types of electromagnetic radiation, including ultraviolet (UV) radiation (e.g. having a wavelength of or about 365, 355, 248, 193, 157 or 126 nm) and extreme ultra-violet (EUV) radiation (e.g. having a wavelength in the range of 5-20 nm), as well as particle beams, such as ion beams or electron beams.

The term “lens”, where the context allows, may refer to any one or combination of various types of optical components, including refractive, reflective, magnetic, electromagnetic and electrostatic optical components.

While specific embodiments of the invention have been described above, it will be appreciated that the invention may be practiced otherwise than as described. For example, the invention may take the form of a computer program containing one or more sequences of machine-readable instructions describing a method as disclosed above, or a data storage medium (e.g. semiconductor memory, magnetic or optical disk) having such a computer program stored therein.

The descriptions above are intended to be illustrative, not limiting. Thus, it will be apparent to one skilled in the art that modifications may be made to the invention as described without departing from the scope of the claims set out below.

What is claimed is:

1. A method of measuring a magnification of a projection system of a lithographic projection apparatus which has an image sensor capable of sensing an aerial image projected by the projection system, the method comprising:
projecting an image of a component of a two-component marker, the two-component marker being sensitive to overlay errors between printing of its two components; and
measuring the position of the component of the two-component marker in the projected image using the image sensor.

2. A method according to claim 1, wherein the image sensor is mounted on a substrate table of the lithographic projection apparatus.

3. A method according to claim 2, wherein the image sensor comprises a plurality of photo-sensitive detectors at least one of said photo-sensitive detectors having an opaque layer in which a grating is formed by transmissive portions.

4. A method according to claim 3, wherein the image sensor comprises a photo-sensitive detector having no overlying grating.

5. A method according to claim 2, wherein the photo-sensitive detector has no overlying grating and has dimensions in the range of from 10 to 40 μm.

6. A method according to claim 1, wherein the image sensor is a transmission image sensor.

7. A method according to claim 1, wherein the sensor comprises a reflection image sensor.

8. A method according to claim 1, wherein the two-component marker is a box-in-box marker.

9. A method according to claim 1, wherein the image that is projected further comprises an image of a component of a second two-component marker and wherein the step of measuring is repeated to measure the position of the component of the second two-component marker.

10. A method according to claim 1, wherein the image further comprises an image of at least a part of a layer of a device.

11. A device manufacturing method using a lithographic projection apparatus which has a projection system and an image sensor capable of sensing an aerial image projected by the projection system, the method comprising:
projecting an image of a component of a two-component marker, the two-component marker being sensitive to overlay errors between printing of the two components;
measuring a position of the component of the two-component marker in the projected image using the image sensor;
determining, from the measured position, a value indicative of the magnification of the projection system; and
projecting the image onto a substrate.

12. A method according to claim 11 further comprising, before projecting the image onto the substrate, adjusting the magnification of the projection system.

13. A method according to claim 11 further comprising:
developing the substrate to reveal a printed image of the two-component marker,
measuring a position of the printed image of the two-component marker using an off-line tool;
determining, from the measured position of the printed image, a second value indicative of the magnification of the projection system.

14. A method according to claim 13, further comprising calibrating a part of the lithographic apparatus using the values indicative of the magnification of the projection system.

15. A computer program product comprising program code to control a lithographic apparatus, which has a projection system and an image sensor capable of sensing an aerial image projected by the projection system, to perform a method of measuring the magnification of the projection system, the method comprising:
projecting an image of a component of a two-component marker, the two-component marker being sensitive to overlay errors between printing of the two components; and
measuring a position of the component of the two-component marker in the projected image using the image sensor.

16. A computer program product comprising program code to control a lithographic apparatus, which has a projection system and an image sensor capable of sensing an aerial image projected by the projection system, to perform a device manufacturing method comprising:
projecting an image of a component of a two-component marker, the two-component marker being sensitive to overlay errors between printing of the two components;
measuring a position of the component of the two-component marker in the projected image using the image sensor;
determining, from the measured position, a value indicative of the magnification of the projection system; and
projecting the image onto a substrate.

17. A method comprising using a transmission image sensor to detect a part of an aerial image of an overlay marker.

18. A method comprising using a sensor mounted on a substrate table in a lithographic projection apparatus to detect a property of a part of an aerial image, wherein the sensor has an opaque layer having transmissive portions therein in the form of a first marker and the part of the aerial image of which a property is detected is an image of a second marker that is different in form than said first marker.

19. A method of measuring the magnification of a projection system of a lithographic projection apparatus which has an image sensor capable of sensing an aerial image projected by the projection system, the image sensor being mounted on a substrate table of the apparatus and having an opaque layer patterned in correspondence to an alignment marker comprising a plurality of gratings, the method comprising:
projecting an image of a component of a two-component marker, the two-component marker comprising first and second boxes, the first box being open and the second box being located inside the first box; and
measuring a position of the component of the two-component marker in the projected image using the image sensor.
